(19) United States
(12) Patent Application Publication
(10) Pub. No.: US 2002/0149168 A1
(43) Pub. Date: Oct. 17, 2002

(54) Elevating manual wheelchair

(76) Inventor: David Keith Brown, Lancaster, CA (US)

Correspondence Address: DAVID KEITH BROWN, 15845 Sweetaire Avenue, Lancaster, CA, 93535, US

(21) Appl. No.: 09/835,966

(22) Filed: Apr. 17, 2001

(51) Int. Cl. B62M 1/14

(52) U.S. Cl. 280/250.1

(57) ABSTRACT

The subject of this patent specification is a new and extremely innovative wheelchair design, which will allow the users to easily and temporarily elevate themselves to a height greater than that of an able bodied person standing, in order to access things which are presently out of their reach, while remaining within the same size and performance constraints as most conventional manual wheelchairs. The invention accomplishes this through a new and unique elevating mechanism of the scissor type, designed to provide exceptional performance, and extreme stability especially in the fully elevated position. The invention is designed to be a general purpose, utility wheelchair, designed to assist the user with his/her day to day living and transportation. The invention also is designed to incorporate all of the features which are standard on other top of the line wheelchairs, thereby rendering it “state of the art” by today's standards, notwithstanding the new elevating feature it incorporates. In addition to making these units capable of elevating the wheelchair user to the height greater than that of an able bodied person standing, one of the primary design objectives of this project, was to make a chair that would do this safely, and securely, as there can be no chance of the user falling out of the chair, or otherwise injuring himself/herself in any way. Toward this end, we have incorporated many advanced safety features, in order to make this product as safe and secure as it possibly can be, and the invention incorporates a new and unique braking/stabilization system which actually engages the ground at two widely dispersed points thereby preventing the wheelchair from moving and providing stability during elevation much more effectively than conventional brakes applied to the wheels. Furthermore, these units have been designed as a modular system, making them adaptable to the specific requirements of people with various disabilities, while generally using standard, off the shelf components.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This project began as a result of a large number of wheelchair users whom we had contact with requesting a wheelchair which would elevate them to the height of an able bodied person standing, as they all regarded not being able to access things at high levels as being their greatest handicap. At present, it is possible to generally adapt most homes to a wheelchair, through the construction of custom built kitchens and other facilities, where all cabinets etc. are positioned at a level that can be accessed from a conventional wheelchair, however the cost of doing so is prohibitive for most wheelchair users, and these measures are also only effective as long as the person is within the confines of their own home, and as soon as they go somewhere else, everything is once again out of reach. Even simple things like changing a light bulb, can prove to be insurmountable problems, when a person simply can't get to it, and therefore, the benefits of a product such as this, should be readily apparent. In this instance, the wheelchair which is the subject of this specification, will quite literally adapt the person to the world, instead of the world having adapt to the wheelchair.

In regards to prior art, although quite a number of patents have been filed on various elevating wheelchair designs, several of which will elevate the user to a substantial height, virtually all of these designs are impractical for one reason or another, and there is currently no wheelchair with this capability currently in production and on the market, either in the United States, or elsewhere in the world.

### BRIEF SUMMARY OF THE INVENTION

The purpose of this project has been to develop a new, and extremely innovative wheelchair design, which will allow the users to easily and temporarily elevate themselves to a height greater than that of an able bodied person standing, in order to access things which are presently out of their reach, while remaining within the same size and performance constraints as most conventional manual wheelchairs. The invention is designed to be a general purpose, utility wheelchair, designed to assist the user with his/her day to day living and transportation. The invention also is designed to incorporate all of the features which are standard on other top of the line wheelchairs, thereby rendering it “state of the art” by today's standards, notwithstanding the new elevating feature it incorporates.

In addition to making these units capable of elevating the wheelchair user to the height greater than that of an able bodied person standing, one of the primary design objectives of this project, was to make a chair that would do this safely, and securely, as there can be no chance of the user falling out of the chair, or otherwise injuring himself/herself in any way. Toward this end, we have incorporated many advanced safety features, in order to make this product as safe and secure as it possibly can be. Furthermore, these units have been designed as a modular system, making them adaptable to the specific requirements of people with various disabilities, while generally using standard, off the shelf components.

### BRIEF DESCRIPTION OF THE SEVERAL VIEWS OF THE DRAWING

Sheet 1;

Illustrates the primary function of the wheelchair, which is to elevate the user to a height greater than that of an able bodied person standing. This view is suitable for publication in the “OFFICIAL GAZETTE” as well as for use on the front page of the patent.

Sheet 2;

FIG. 1—Rear view of the wheelchair with the elevating mechanism in the lower or retracted position, and the braking system disengaged.

FIG. 2—Side view of the wheelchair with the elevating mechanism in the lower or retracted position, and the braking system disengaged.

Sheet 3;

FIG. 3—Side view of the elevating mechanism in the upper or extended position.

FIG. 4—Side view of the elevating mechanism in the lower or retracted position.

FIG. 5—End and top view of the central frame of the upper portion of the elevating scissor assembly.

FIG. 6—End and top view of the central frame of the lower portion of the elevating scissor assembly.

Sheet 4;

FIG. 7—Rear view of the wheelchair with the elevating mechanism in the lower or retracted position, and the braking system disengaged, illustrating the swing out/removability feature of the armrests.

FIG. 8—Side view of the wheelchair with the elevating mechanism in the lower or retracted position, and the braking system engaged. This view when compared to FIG. 2 also illustrates various features of the wheelchair, such as the infinitely adjustable angle of the seat to accommodate various users, the removal of the foot rest and adjustment of the front caster position to accommodate leg amputees, and the range of adjustment that can be made to the placement of the rear wheels to accommodate the preferences of various users.

### DETAILED DESCRIPTION OF THE INVENTION

This invention entails a manually propelled wheelchair, incorporating a mechanism to elevate the user to a height greater than that of an able bodied person standing, and it shall also be noted that this mechanism can be applied equally well to a power driven wheelchair. It also incorporates an advanced new braking/stabilizing system to ensure the stability of the unit when the elevating mechanism is in use. Furthermore, this unit is of a modular design, which enabled it to be particularly adapted to the specific needs and requirements of specific individuals, and incorporates all of the features and adjustment capabilities necessary to render it “state of the art” by today's standards.

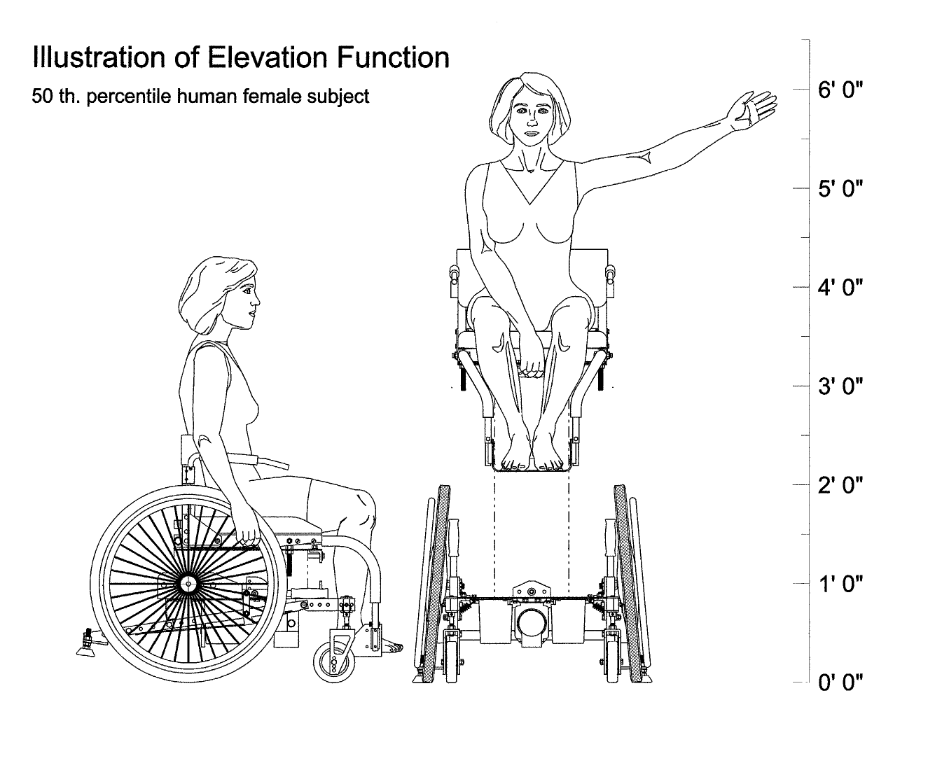

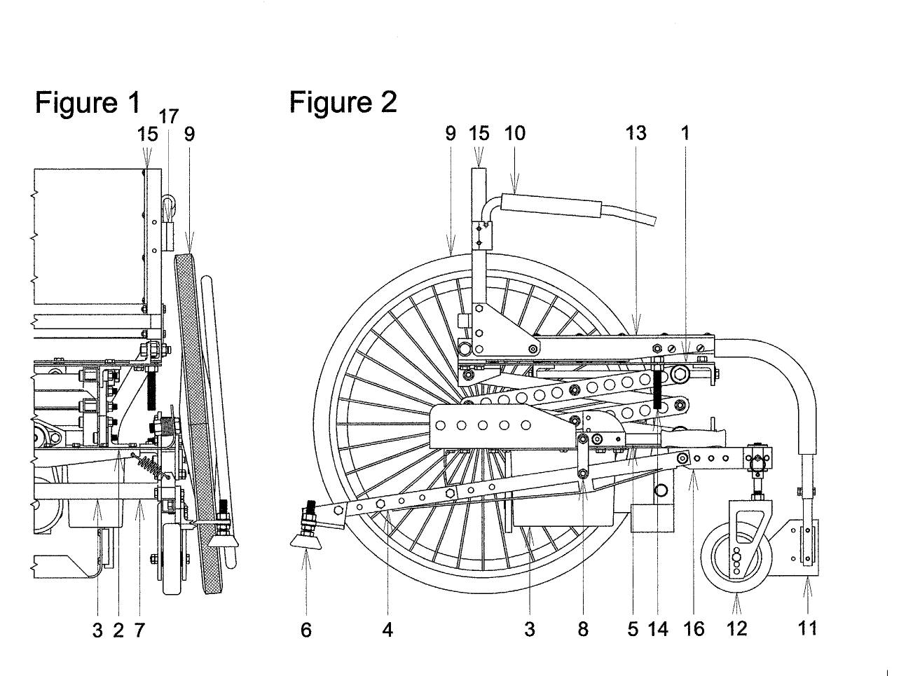

The general configuration of the wheelchair is depicted in FIGS. 1 and 2, showing a rear view and a side view of the unit respectively. The wheelchair is manufactured primarily from various aluminum alloy plates, angles, and other structural forms, and several steel components, using common welding, machining, and forming processes.

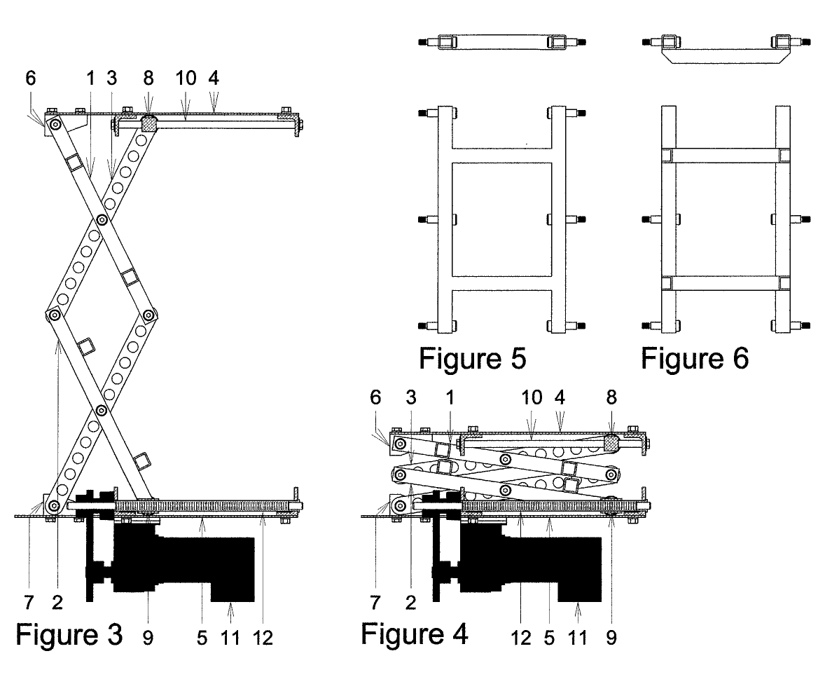

This wheelchair incorporates an advanced elevating mechanism of the single scissor type. The elevating mechanism is located between the seat mounting plate (FIG. 2, No. 1), and the main carriage (FIG. 1 No. 2) of the wheelchair. The operation of the elevating mechanism is illustrated in FIG. 3, which shows it in the upper or extended position, and in FIG. 4, which shows it in the lower or retracted position. One of the unique aspects of this elevating mechanism is that it incorporates two or more solid central frames which are illustrated in FIGS. 5 and 6, as well as in FIGS. 3 and 4, No. 1 and 2, which separate the external arms of the scissor mechanism, and distribute the load on the scissor mechanism over a much wider area that would be possible with any other scissor configuration. The purpose of these frames is to greatly increase the stability and rigidity of the mechanism and the support it provides to the operator, especially in elevated positions, than would be possible with a conventional double scissor mechanism, consisting of two separate bar arrangements side by side. The scissor central scissor frames (FIGS. 3 and 4, No. 1 and 2) are connected by several scissor arms (FIGS. 3 and 4, No. 3) which incorporate anti friction bushings, and engage corresponding pins, or shoulder screws provided in both sides of the central scissor frames, allowing the components to rotate freely in relation to each other. The rearward portion of the scissor mechanism is mounted to the rear of the seat mounting plate (FIGS. 3 and 4, No. 4) and the main carriage (FIGS. 3 and 4, No. 5) with corresponding brackets (FIGS. 3 and 4, No. 6 and 7) and pins or shoulder screws, and bushings, again allowing the components to rotate freely in relation to each other. The forward portions of the scissor mechanism are connected by aluminum bars (FIGS. 3 and 4, No. 8 and 9) via pins or shoulder screws, again allowing them to rotate freely in relation to the other components. The upper aluminum bar (FIGS. 3 and 4, No. 8) engages two rods (FIGS. 3 and 4, No. 10) provided under the seat mounting plate, which serves to prevent the seat assembly from tipping rearward. The lower aluminum bar (FIGS. 3 and 4, No. 9) engages the mechanism used to activate the scissor mechanism. Both the upper and lower forward ends of the scissor mechanism are provided with ball bearings, which ride against the seat mounting plate and the main carriage, thereby ensuring friction free movement of the mechanism. Alternately, these ends could be supported by rods or tracks, engaging corresponding bearings or bushings, or any other system that would allow the components to move back and forth freely. In this particular application of the invention, an electric motor (FIGS. 3 and 4, No. 11) is connected to a drive screw (FIGS. 3 and 4, No. 12) via roller chain and sprockets. The drive screw engages the lower aluminum bar and forces it back or forward, depending on the direction of rotation of the motor, to operate the scissor mechanism, and move the user up or down as required. The drive screw is provided with a suitable bearing, which will accommodate both the radial and axial trust it is subjected to. The motor is powered by electric batteries (FIGS. 1 and 2, No.3), and can be operated by the user via an electric switch mounted on or about the seat assembly at whatever point may be convenient, and allows the operator to stop the unit at any point during it's vertical travel which may be convenient for the task he/she wishes to accomplish. This system also incorporates two limit switches to stop the motor when the scissor mechanism reaches it's upper and lower limits of travel. Alternately, the unit can be powered by an electric linear actuator, or a hydraulic cylinder mounted to the lower aluminum bar, and secured to the rear of the main carriage. The hydraulic cylinder may be powered either by an electric hydraulic pump, or alternately by a hand operated hydraulic pump, eliminating the need for motors and batteries. Alternately, this mechanism may also be powered by a winch and chain or cable assembly engaging the lower aluminum bar, and mounted to the rear of the main carriage, or even by a manually driven screw mounted under the seat mounting plate. It shall be noted that this mechanism can be applied to a power driven wheelchair equally well as it can be applied to the manually propelled wheelchair detailed in this patent specification. Furthermore, the range of upward travel may be increased by adding additional sections to the scissor mechanism, however the number provided should be more than adequate for the requirements of most users.

Although there are numerous patents describing various mechanisms used to elevate the user of a wheelchair to substantial heights, the only existing patent which we were able to locate which is even remotely similar to the mechanism used on this wheelchair is U.S. Pat. No. 5,601,302. The wheelchair which is the subject of this patent is an electrically propelled unit, and incorporates a double scissor mechanism, which appears to incorporate two separate and parallel scissor mechanisms manufactured from bar stock, spaced a few inches apart, connected to a single vertically placed linear actuator to operate the mechanism. For reasons stated in the preceding paragraph, this arrangement, while it will effectively perform it's function of elevating the user to a substantial height, appears to be inherently unstable due to it's design, and the only way to provide any reasonable degree of stability and comfort to the user at elevated positions would if possible, be to machine the components of this system to much tighter tolerances than are standardly available in normal machine shop practice, making the unit very expensive, and consequently subject to wearing out before an acceptable period of time.

This wheelchair also incorporates an advanced braking and stabilization system to provide exceptionally stable support for the wheelchair, especially when the user is in the elevated position. Instead of simply locking the rear wheels as conventional wheelchair brakes do, this system provides a set of stabilizing arms (FIG. 2, No.4), which are lowered by the operation of two brake handles (FIG. 2, No. 5), which stabilizing arms are provided with rubber feet on their ends (FIG. 2, No.6), which engage the ground and provide solid support for the wheelchair at two widely dispersed points, thereby effectively preventing the unit from moving while the system is applied. The two stabilizing arms are rigidly connected to each other by a bar (FIG. 1, No.7) spanning the distance between them, providing extra stability for the system. This assembly is mounted to the front caster supports (FIG. 2, No. 16) via pins or shoulder screws, allowing it to rotate freely as required. The braking/stabilizing system is activated by the operator pulling upward on the brake handles. The brake handles are connected to the stabilizing arms via a connecting link (FIG. 2, No.8), which cams the stabilizing arms downward as the brake handles are pulled upward/rearward, and are mounted to brackets provided on the main carriage (FIG. 1, No. 2) via pins or shoulder screws. again allowing them to rotate freely as required. As the brake handles reach their uppermost/rearmost position, the connecting links are made to snap into an over center position, thereby effectively locking the stabilizing arms in the downward position until the brake handles are deliberately pushed forward/down by the operator to disengage the system. The braking/stabilizing system is illustrated in it's down/engaged position in FIG. 8, as compared to the upper/disengaged position illustrated in FIG. 2. Two extension springs are incorporated in the system, attached at one end to both of the braking/stabilizing arms, and at the other end to the main carriage assembly, to hold the braking/stabilizing system in it's upper/disengaged position when it is not in use. The stabilizing arms are adjustable in length, as is the position of the rubber feet, which can be mounted either on the outside of the stabilizing arms, behind the wheels, or on the inside of the stabilizing arms so as not to protrude beyond the perimeter of the wheels, for increased convenience in handling. All of these positions have been found to be more than sufficiently stable to support the wheelchair when the user is in the elevated position.

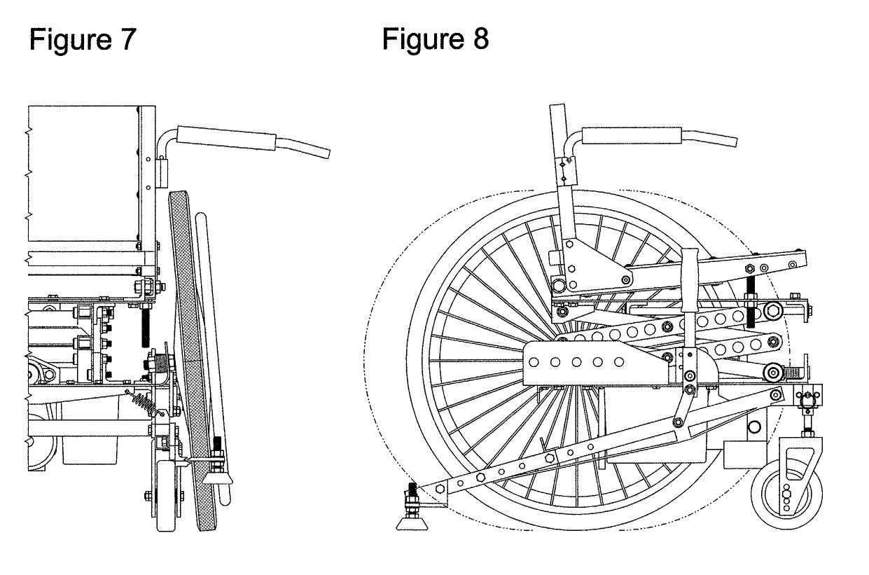

Of the remaining features and components incorporated in this wheelchair, most are fairly standard, and are similar to components and featured incorporated on most of the better wheelchairs being manufactured at the present time. The rear wheels, consisting of standard wheelchair wheels, push rims, and tires (FIGS. 1 and 2, No.9), may be adjusted in regards to their position as illustrated in FIG. 8 by attaching them to various mounting holes provided in the main carriage assembly (FIG. 1, No. 2), to suit the individual preferences of each user, and are also removable via quick release pins, to facilitate greater ease of storage in confined spaces. The arm rests (FIG. 2, No. 10) are removable simply by lifting them out of their sockets (FIG. 1, No. 17) which are fastened to the backrest assembly (FIG. 1 and 2, No. 15), and can also be rotated to the side and rear to facilitate easier transferring in and out of the wheelchair, as illustrated in FIG. 7. When in the traveling position, the armrests are held forward by two pins which drop into corresponding slots in their sockets. The leg/foot rest assembly (FIG. 2, No. 11) is adjustable for length in order to accommodate the size and build of each individual user, and is easily removable via attachment with knurled hand knobs to facilitate greater ease of storage in confined spaces. The position of the front casters (FIG. 2, No. 12) may be adjusted via bolts engaging spaced holes provided in the carriage assembly as illustrated in FIG. 8 as compared to their position in FIG. 2, and this in combination with the removal of the leg/foot rest assembly will allow leg amputees to get closer to objects from the frontal as well as lateral positions. Since these users have no front weight, the extra stability provided by extending the casters forward is simply not needed. The front casters are also removable via quick release pins, again to facilitate greater ease of storage in confined spaces. The seat assembly (FIG. 2, No. 13), which is hinged on two bolts or pins mounted to corresponding brackets provided at the rear of the seat mounting plate, may be infinitely adjusted as to it's incline via two adjustment screws (FIG. 2, No. 14), which engage corresponding pins provided in the seat assembly, as well as corresponding slots in the seat mounting plate (FIG. 2, No. 1) and are held in position by nuts tightened against either side of the seat mounting plate. This feature is illustrated in FIG. 8 as compared to FIG. 2. The back rest assembly (FIGS. 1 and 2, No. 15) is of the standard low back type, and is hinged on the seat assembly, and locked in the vertical position by two quick release buttons, which enable it to be released and folded forward onto the seat assembly to facilitate greater ease of storage in confined spaces. A pivoting high back rest can also be attached to the present back rest assembly to accommodate the specific preferences of individual users.

What I claim as my invention is:

1; A manually propelled or power driven wheelchair, incorporating a mechanism to elevate the user to any desired height, from a height equal to or less than a standard seated height up to a height greater than that of an able bodied person standing, where said mechanism shall be of the single scissor type, consisting of a number of wide, centrally located internal frames connected by a series of external scissor arms rotatably mounted at corresponding points on either side of the internal frames, said mechanism being rigidly but rotatably fastened to the corresponding members of the wheelchair at one end, and slidably fastened at the other, where said mechanism may be powered by either an electric motor and screw assembly, a linear actuator, an electrically or manually powered hydraulic system, a manually powered screw system, or a winch and chain or cable assembly, to adjust the height of said single scissor mechanism.

2; A manually propelled wheelchair, incorporating a braking and stabilization system attached to the wheelchair, and consisting of a set of rotating arms which drop down to engage the ground at two separate and widely dispersed points, where the operation of said mechanism may be achieved through manually operated levers, or electric and/or hydraulic means.
